(19) United States
(12) Patent Application Publication
(10) Pub. No.: US 2015/0079317 A1
(43) Pub. Date: Mar. 19, 2015

(54) METHOD FOR PRODUCING A THERMAL INSULATION BODY

(71) Applicant: SGL CARBON SE, Wiesbaden (DE)

(72) Inventors: BODO BENITSCH, BUTTENWIESEN (DE); SINISA MILOVUKOVIC, BIBERBACH (DE)

(21) Appl. No.: 14/551,297

(22) Filed: Nov. 24, 2014

Related U.S. Application Data
(63) Continuation of application No. PCT/EP2013/060545, filed on May 22, 2013.

(30) Foreign Application Priority Data
May 23, 2012 (DE) 102012208595.5

(51) Int. Cl. F16L 59/02; B32B 1/08; B32B 7/04; B32B 38/00

(52) U.S. Cl. CPC F16L 59/028; B32B 38/0004; B32B 1/08; B32B 7/04; B32B 2250/05; B32B 2250/20; B32B 2262/106; B32B 2307/304; B32B 2313/04; B32B 2597/00
USPC 428/34.1; 156/245

(57) ABSTRACT

A thermal insulation body is made from a material that includes carbonized fibers and/or graphitized fibers. A sheet-like molding that is made of the material is provided. The molding has at least one first curved portion and at least one second curved portion. The two or more curved portions have an opposite curvature relative to one another, based on at least one spatial direction. Then the first curved portion is separated from the second curved portion, in that the molding is split so as to obtain at least one first curved individual part and a second curved individual part. The individual parts are joined to form a thermal insulation body such that said body has a curvature which continues in a uniform manner based on the spatial direction.

### CROSS-REFERENCE TO RELATED APPLICATION

This application is a continuation, under 35 U.S.C. §120, of copending international application No. PCT/EP2013/060545, filed May 22, 2013, which designated the United States; this application also claims the priority, under 35 U.S.C. §119, of German patent application No. DE 10 2012 208 595.5, filed May 23, 2012; the prior applications are herewith incorporated by reference in their entirety.

### BACKGROUND OF THE INVENTION

1. Field of the Invention

The present invention relates to a method for producing a thermal insulation body from a material comprising carbonized fibers and/or graphitized fibers and in particular from a felt material comprising carbonized fibers and/or graphitized fibers.

Thermal insulation bodies made of carbon felts are used, for example, in high-temperature systems in the production of silicon monocrystals. High-temperature processes of this type, which take place for example at a temperature of over 800° C. in an inert atmosphere, place high thermal and mechanical demands on the insulating materials used. Insulating bodies which line for example an inner chamber of a high-temperature furnace and thus separate the heat chamber from the cooled outer wall are often produced from carbonized and sometimes graphitized felts. By comparison with the production of a single-piece thermal insulation body, which can take place for example by winding unhardened, resin-impregnated felt layers onto a mandrel and subsequently hardening the felt material, the production of a thermal insulation body from a plurality of individual pieces offers the advantage of lower levels of raw material waste and more efficient high-temperature post-treatment of the felt material.

Commonly assigned U.S. published patent application US 2007/0259185 A1 and its counterpart European patent EP 1 852 252 B1 describe a method for producing high-temperature-resistant insulating bodies, in which, inter alia, a plurality of curved segments made of a material based on a graphite expandate which is compressed to a density of between 0.02 and 0.3 g/cm³ are assembled to form a hollow cylindrical component. In this case, the cohesion of the individual segments is ensured by a carbonized binder which contains planar, anisotropic graphite particles. A graphite film is also arranged on the inner surface of the hollow cylindrical insulating body.

U.S. Pat. No. 8,525,103 B2 and its counterpart international PCT publication WO 2011/106580 A2 describe an insulating body for a reactor, which body is produced from a carbon fiber material and is assembled from a plurality of plate-like individual components. The individual components can be coupled by means of tongue-and-groove connections using additional connection elements.

A problem with thermal insulation bodies assembled from a plurality of individual parts is that there are often relatively high levels of raw material waste. This occurs particularly when curved components have to be produced from flat plates, as is the case for example with cylindrical insulation produced in a near-net-shape. In addition, thermal insulation bodies made of carbon-based felts have to undergo high-temperature treatment in order to carbonize and graphitize the starting product. With a plurality of individual parts, this high-temperature treatment is often inefficient, since placing a large number of individual parts in a corresponding furnace is time-consuming and often has to be facilitated by loading aids, which mean that the furnace can only be loaded at a relatively low packing rate. In particular in the case of irregularly shaped, sharply curved or even hollow cylindrical parts, an undesirably high dead volume is produced in the heating chamber. In addition, the shaping of a plurality of differently shaped individual parts, for example by hot-pressing, is associated with high costs owing to the number of press molds to be provided.

### SUMMARY OF THE INVENTION

It is accordingly an object of the invention to provide a method of producing a thermal insulation body which overcomes the above-mentioned and other disadvantages of the heretofore-known devices and methods of this general type and which allows for thermal insulation bodies made of felts comprising carbon fibers to be produced in a simpler and more economical manner, without running the risk of reducing the insulating action or the mechanical stability in the process.

With the foregoing and other objects in view there is provided, in accordance with the invention, a method of producing a thermal insulation body, the method comprising the following steps:

a) providing at least one molding in sheet form and made of a material including carbonized fibers and/or graphitized fibers, the molding having at least one first curved portion and at least one second curved portion, the first portion and the second portion having curvatures opposite one another in at least one spatial direction;

b) splitting the molding to separating the at least one first curved portion from the at least one second curved portion, in order to thereby obtain at least one first curved individual part and at least one second curved individual part; and

c) joining the individual parts to one another to thereby form a thermal insulation body having a curvature that is uniformly continuous based on the spatial direction.

In other words, the objects of the invention are achieved by a method for producing a thermal insulation body made from a material that includes carbonized fibers and/or graphitized fibers. According to the method, at least one sheet-like molding is provided with one or more first curved portions and one or more second curved portions. The first portion and the second portion alternate and they have an opposite curvature based on at least one direction in space. The first curved portions are separated from the second curved portions by splitting the molding such as to obtain at least one first curved individual part and one second curved individual part. Then the individual parts are joined to form a thermal insulation body, such that the body has a curvature which continues in a uniform manner based on the direction in space.

At least one sheet-like molding made of a material comprising carbonized fibers and/or graphitized fibers, and more specifically preferably made of a hardened felt material comprising carbonized fibers and/or graphitized fibers, is provided according to the invention, the molding comprising at least one first curved portion and at least one second curved portion, and the first portion and the second portion having an opposite curvature based on at least one direction in space. The first curved portion is separated from the second curved portion by splitting the molding, so as to obtain at least one first curved individual part and one second curved individual part. The individual parts are then joined to form a thermal insulation body such that said body has a curvature which continues in a uniform manner based on the spatial direction.

Within the meaning of the present application, splitting the molding is understood to mean creating at least two separate individual parts from a component which was originally a single-piece component, the splitting not necessarily having to be carried out by halves. A sheet-like molding is understood to be a molding which has no cavities and the extension of which is considerably smaller in one particular direction in space than in the other two directions in space. The smaller extension is then typically referred to as “thickness”.

It should further be noted that, within the meaning of the present application, a curvature which continues in a uniform manner is meant to be a curvature path that does not alternate, from a positive curvature to a negative curvature, i.e. does not have an inflection point, the value of the curvature not necessarily having to be same everywhere.

Since the molding has two portions curved in opposite directions, in other words e.g. has an S-shaped cross section, overall the curvature is smaller with respect to the component. The molding can thus be handled more easily than if the two portions were curved in the same direction. In particular, it is possible to arrange a plurality of moldings in a high-temperature system, e.g. during the carbonization or graphitization required to produce carbon-based felts, at a relatively high packing rate, since, owing to the curvatures extending in different manners, the molding is not molded in the manner of a hollow profile, but rather more in the manner of a plate. Therefore, this can considerably reduce the undesirable dead volume in the heating chamber of a high-temperature system.

According to the invention, it has been found in particular that it is more advantageous in terms of production to provide portions, which are curved in different manners and are to be separated later, during the shaping of a starting component and thereby accept the additional separation process step, since the overall efficiency of the production can be considerably increased by comparison with the typical approach, according to which the individual parts are molded separately or the thermal insulation body is actually produced as a single piece. The high-temperature treatment itself in a corresponding furnace system is namely particularly time-consuming and costly, and therefore increasing the efficiency has a particularly positive effect on the entire production process in this case too.

Preferably, in step a) a molding is provided, in which the curvature of the first portion and the curvature, in the opposite direction thereto, of the second portion compensate each other. A molding is thus provided which, on first glance, i.e. effectively as an average over the entire extension of the molding, is not curved. A “virtually flat” molding of this type is not only simpler to produce than e.g. a sharply curved plate or a hollow profile, but is also simpler to handle, for example, to stack.

A preferred embodiment of the invention provides that in step b), the molding is split at an inflection point, at which the curvature behavior of the molding changes based on the direction in space. In the subsequent joining of the individual parts to form one thermal insulation body in step c), a transition which is relatively uniform with respect to the curvature can thus be achieved following a corresponding rotation and/or displacement of one of the individual parts.

Preferably, in step a) a molding is provided, which has at least two additional curved portions, each of the curvatures of two successive portions compensating each other. In this embodiment of the method according to the invention, it is possible to provide a plurality of curvatures while maintaining the overall plate-like nature of the molding.

According to a particularly advantageous embodiment of the present invention, in step a) a molding having an undulating cross section is provided. An undulated plate or corrugated plate of this type is particularly simple to produce and handle.

In step c), the individual parts can be joined together to form a thermal insulation body which forms a hollow profile, which is closed at least locally, in at least one cross-sectional plane extending in the direction in space. Hollow profiles of this type are particularly suitable for lining the heating chamber of a high-temperature furnace.

In particular, in step c) the individual parts can be joined to form a thermal insulation body in the form of a hollow cylinder, the cylinder longitudinal axis extending perpendicularly to the direction in space. For technical and commercial reasons, high-temperature furnaces often have a cylindrical inner chamber. An inner chamber of this type can be insulated in a simple manner by means of a hollow cylindrical thermal insulation body.

In order to achieve uniform insulation and consistent strength with no weak points in the thermal insulation body, it is preferable for a sheet-like molding having a uniform thickness to be provided in step a).

It is also advantageous if the molding is split in step b) such that the individual parts have an identical shape. This simplifies not only the assembly, but also possible intermediate storage of the individual parts. The uniformity of the components also provides a certain level of redundancy, so that faulty components can be replaced quickly and simply.

In step b), the molding can be split in particular by being cut apart, sawn apart or milled apart. Depending on the application, however, it is also possible to use other separation methods, e.g. thermal, chemical or electrochemical separation methods, and laser beam or water jet cutting.

A preferred embodiment of the invention provides that, before the individual parts are joined according to step b), the second individual part or each second individual part is rotated by 180°. As a result, the curvature behavior of the two individual parts is altered such that both individual parts have curvatures in the same direction based on the direction in space.

To provide the molding in step a), a hardenable starting material can be compressed to form the molding and then hardened. This manner of shaping can be carried out very efficiently, for example by pressing.

In particular comminuted felt elements, comprising carbonized fibers and/or graphitized fibers, in a matrix made of a carbonizable resin can be provided as the hardenable starting material. In connection with the method according to the invention, a felt material of this type has proven to be particularly advantageous. Comminuted felt elements are understood to be felt pieces having a length of less than 10000 mm, preferably of less than 1000 mm and more preferably of less than 100 mm. In particular a phenol resin, a pitch, a furan resin, a phenyl ester, an epoxy resin or any mixture of two or more of the aforementioned compounds can be provided as the resin. Particularly effective insulation can be produced from starting materials of this type.

In this case, the starting material can be pressed with the inclusion of separate reinforcing layers made from a woven fabric, a non-woven fabric, a fibrous structure or a film, preferably a graphite film, or a combination thereof. Such reinforcing layers can considerably improve the mechanical stability, the stability against abrasion and the heat insulating action of the component to be produced.

Preferably, the starting material is pressed in a press mold made of metal. This press mold can advantageously be used to produce a plurality of similar moldings.

In a development of the concept of the invention, it is proposed that the molding is produced such that a press mold having a bottom which has an undulating profile is filled with the pourable starting material, and such that the press mold is closed by a cover following the filling, which cover also has an undulating profile. The undulating profiles of the cover and the bottom are transferred to the molding to be created, which consequently comprises a plurality of alternating cylinder segments. Therefore, the production of an individual molding in the press mold provides the basis for a plurality of cylinder segments, which can later be assembled to form cylindrical bodies.

Preferably, the starting material is subjected to a hot-pressing process in the press mold. A hot-pressing process of this type makes it possible to produce a molding in a particularly efficient manner. Preferably, the hot-pressing process is carried out at a pressure of from 10 to 30 N/cm², more preferably of from 15 to 25 N/cm², at a temperature of from 120° C. to 250° C., more preferably of from 160° C. to 200° C., and/or for a time period of from 60 to 320 minutes, more preferably of from 200 to 280 minutes.

In this case, the starting material can be pre-compressed at room temperature in the press mold prior to the hot-pressing process in order to make the actual hot-pressing more efficient.

In addition, before the splitting, the molding can be subjected to a high-temperature process, which takes place at a temperature of at least 600° C. It is advantageous to subject the molding, and not, for example, the separated individual parts, to the high-temperature process, since in terms of the usable process space it is simpler, quicker and more efficient to arrange the compact molding and preferably a compact stack of moldings in the heating chamber of a high-temperature furnace than a collection of loose individual parts.

Particularly good insulation properties are achieved in this regard if the high-temperature process comprises carbonization carried out at a temperature of from 800° C. to 1200° C. and/or graphitization carried out at a temperature of from 1500° C. to 2200° C. and/or thermal cleaning.

The invention also relates to a thermal insulation body obtainable by means of a method as described above.

Preferably, such a thermal insulation body has a thermal conductivity, measured according to German industrial norm DIN 51936, in the radial direction at 2000° C. of at most 1.5 W/(m·K) and more particularly of at most 0.8 W/(m·K). This ensures adequate insulation for applications with high thermal demands, such as the production of silicon monocrystals.

It is further preferred for a thermal insulation body of this type to have a compressive strength, measured according to DIN EN 658-3, and/or a flexural strength, measured according to DIN EN 658-2 and DIN 51910, of at least 0.2 MPa, preferably of at least 0.5 MPa and more preferably of at least 0.8 MPa. A thermal insulation body of this type is sufficiently rigid for the relatively tough mechanical demands in a high-temperature environment

Other features which are considered as characteristic for the invention are set forth in the appended claims.

Although the invention is illustrated and described herein as embodied in a Method for producing a thermal insulation body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a molding provided according to a method according to the invention for producing a thermal insulation body.

FIG. 2 is a side view of the molding according to FIG. 1.

FIG. 3 is an enlarged detail of the view according to FIG. 2.

FIG. 4 shows a thermal insulation body that has been produced by a method according to the invention.

### DETAILED DESCRIPTION OF THE INVENTION

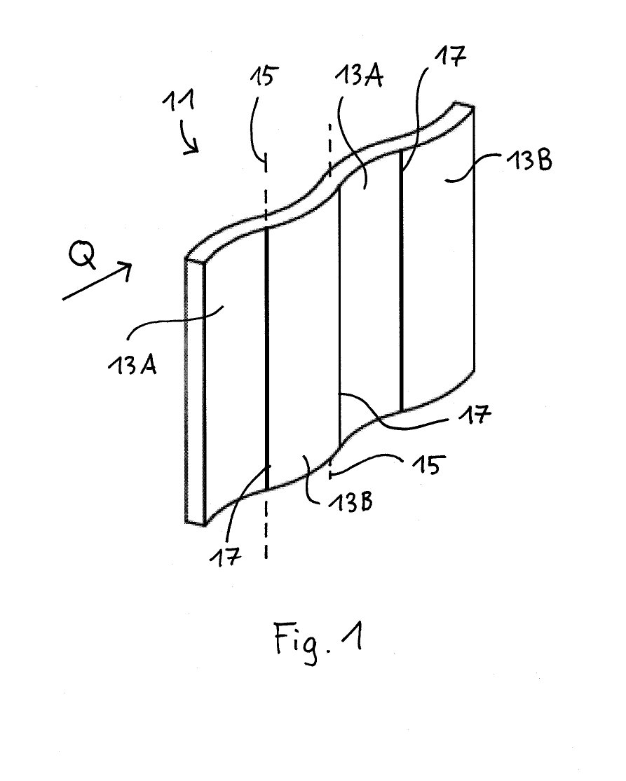

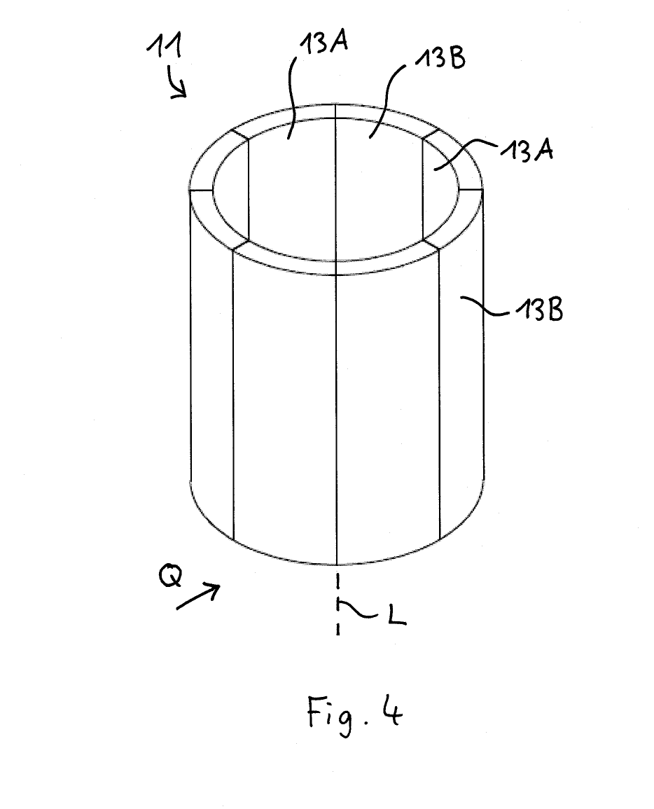

Referring now to the figures of the drawing in detail and first, particularly, to FIGS. 1 to 3 thereof, there is described a method for producing a hollow cylindrical thermal insulation body made of a felt material comprising carbonized fibers and/or graphitized fibers, forming a sheet-like molding 11 made of hardened carbon felt in the form of a corrugated plate.

To produce the molding 11, firstly a pourable, hardenable starting material is created by carbonized and graphitized, chopped felt elements being mixed with a pulverulent synthetic resin having a sufficiently high carbon yield until an adequate degree of mixing is achieved. Next, a press mold, which is closed on five sides and which is preferably made of metal, is filled with a loose filling of the starting material. In this context, the filling height is preferably initially selected to be approximately 2 to 5 times higher than the desired final thickness of the molding to be created. The press mold has a bottom, or mold floor, having an undulating contour.

Once the press mold has been filled as uniformly as possible with the pourable starting material, the press mold is closed by a cover which, like the bottom, has an undulating contour. The undulating contours of the bottom and cover are shaped such as to produce a homogenous thickness of the molding, based on the surface normal of its outer faces, once the cover has been lowered to the desired final position. The cover is now pushed towards the bottom of the press mold inside the stationary inner walls of the press mold. It is thereby possible to first carry out a pre-compression at room temperature. Then, the press mold is fed to a hot-press and the starting material is compressed at a pressure of approximately 20 N/cm² and a temperature of approximately 180° C. for approximately 240 minutes. The starting material is hardened as a result. Following hardening, the molding 11 can be removed from the press mold as an inherently stable component.

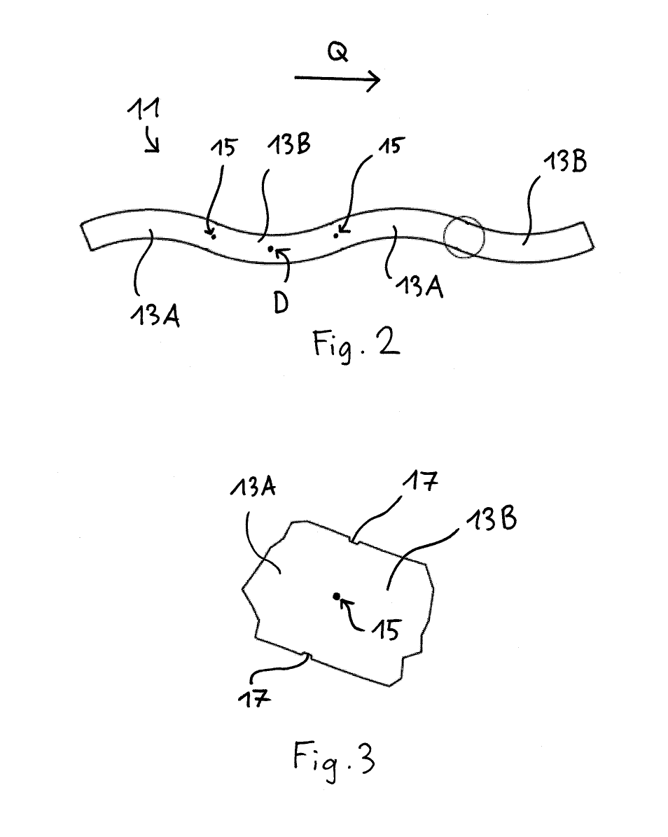

Owing to the undulation of the bottom and cover of the press mold, the molding 11 is formed into an undulated plate, in which, when viewed in a transverse direction Q, arcuate cylinder segments 13A, which are bent upwards according to FIG. 2, and cylinder segments 13B, which are bent downwards according to FIG. 2, follow each other in alternation. The curvature behavior of the molding 11 thus changes in each case at inflection lines 15 which extend in parallel with one another and perpendicularly to the transverse direction Q. The direction Q, relative to the molding 11 or the molding parts, is a spatial direction that may also be seen as a tangent line, in particular after the partial segments 13A and 13B are joined to form a cylinder (FIG. 4).

The undulated molding 11 then undergoes post-treatment. Specifically, a carbonizing process is carried out at approximately 900° C., followed by a graphitization process at approximately 2200° C. and, as necessary, a subsequent additional thermal cleaning. This post-treatment produces an insulating material which can be used in an inert atmosphere at temperatures of 2000° C. It has surprisingly been found that an insulating material pressed and thermally treated in this manner has a thermal conductivity, measured according to DIN 51936, in the radial direction at 2000° C. of at most 1.5 W/(m·K) at every point of the corrugated plate profile.

The molding 11 is then cut along the inflection lines 15. The differently curved cylinder segments 13A, 13B are thereby separated from one another. To facilitate cutting, indentations 17 are provided along the inflection lines 15 on both outer faces of the molding 11.

The cylinder segments 13A, 13B are then joined back together, although all the cylinder segments 13B that are bent upwards according to FIG. 2 are rotated about an axis of rotation D which extends parallel to the inflection lines 15, and therefore, upon assembly, the curvature behavior of the resulting component no longer changes, but rather a curvature which continues in a uniform manner is present. The rotation could also occur, for example, about an axis that extends parallel to the transverse direction, provided that the change in curvature between the cylinder segments 13A, 13B is maintained.

The cylinder segments 13A, 13B can be joined using joining techniques known in the art, for example by bonding. As many cylinder segments 13A, 13B are joined together as are necessary to produce a closed, hollow cylindrical profile 17 as shown in FIG. 4, which profile has a cylinder longitudinal axis L and can be used as a thermal insulation body in a furnace system having a cylindrical heating chamber.

The following is a summary list of reference numerals and the corresponding structure used in the above description of the invention:
11 Molding
13A Cylinder segment
13B Cylinder segment
15 Inflection line
17 Indentation
Q Transverse direction
D Axis of rotation
L Cylinder longitudinal axis

1. A method of producing a thermal insulation body, the method comprising the following steps:
a) providing at least one molding in sheet form and made of a material including carbonized fibers and/or graphitized fibers, the molding having at least one first curved portion and at least one second curved portion, the first portion and the second portion having curvatures opposite one another in at least one spatial direction;
b) splitting the molding to separating the at least one first curved portion from the at least one second curved portion, in order to thereby obtain at least one first curved individual part and at least one second curved individual part; and
c) joining the individual parts to one another to thereby form a thermal insulation body having a curvature that is uniformly continuous based on the spatial direction.

2. The method according to claim 1, wherein step a) comprises providing the molding with the curvature of the first portion and the curvature, in the opposite direction thereto, of the second portion compensating each other.

3. The method according to claim 1, wherein step b) comprises splitting the molding at an inflection point at which a curvature behavior of the molding changes based on the spatial direction.

4. The method according to claim 1, wherein step a) comprises providing a molding which has at least two additional curved portions, each of the curvatures of two successive portions compensating each other.

5. The method according to claim 1, wherein step a) comprises providing a molding having an undulating cross section.

6. The method according to claim 1, wherein step c) comprises joining the individual parts together to form a thermal insulation body which forms a hollow profile, which is closed at least locally, in at least one cross-sectional plane extending in the spatial direction.

7. The method according to claim 6, wherein step c) comprises joining the individual parts to form a thermal insulation body in the form of a hollow cylinder with a cylinder longitudinal axis extending perpendicularly to the direction in space.

8. The method according to claim 1, wherein step a) comprises providing a sheet-shaped molding having a uniform thickness.

9. The method according to claim 1, wherein step b) comprises separating the molding to form a plurality of individual parts have a mutually identical shape.

10. The method according to claim 1, which comprises, prior to joining the individual parts, rotating the second individual part or each second individual part by 180°.

11. The method according to claim 1, wherein step a) comprises pressing a hardenable starting material and then hardening to form the molding.

12. The method according to claim 11, wherein the hardenable starting material is comminuted felt elements comprising carbonized fibers and/or graphitized fibers in a matrix made of a carbonized resin.

13. The method according to claim 12, which comprises filling a press mold having a bottom with an undulating profile with the starting material in pourable form, and subsequently closing the press mold with a cover also having an undulating profile.

14. The method according to claim 1, which comprises, before splitting the molding into individual parts, subjecting the molding to high-temperature processing at a temperature of at least 600° C.

15. A thermal insulation body obtained by the method according to claim 1.
